(19) United States
(12) Patent Application Publication
(10) Pub. No.: US 2017/0168979 A1
(43) Pub. Date: Jun. 15, 2017

(54) CAPACITIVELY COUPLING DIFFERENTIAL DATA LINES OF A USB2 PHYSICAL LAYER INTERFACE TRANSCEIVER (PHY) TO ONE OR MORE COMPONENTS OF A HIGH SPEED MODULE IN RESPONSE TO A TRANSITION OF THE PHY INTO HIGH SPEED MODE

(71) Applicant: QUALCOMM Incorporated, San Diego, CA (US)

(72) Inventors: Terrence REMPLE, San Diego, CA (US); Sassan SHAHROKHINIA, San Diego, CA (US); Jagadeesh GOWNIPALLI, San Diego, CA (US); Babak MANSOORIAN, San Diego, CA (US); Madjid HAMIDI, San Diego, CA (US)

(21) Appl. No.: 15/359,492

(22) Filed: Nov. 22, 2016

Related U.S. Application Data
(60) Provisional application No. 62/265,171, filed on Dec. 9, 2015.

(51) Int. Cl. G06F 13/42; G06F 13/40

(52) U.S. Cl. CPC G06F 13/4282; G06F 13/4068

(57) ABSTRACT

In an embodiment, a Physical Layer Interface Transceiver (PHY) is configured to operate in accordance with a Universal Serial Bus 2.0 (USB2) protocol. The PHY includes a High Speed module configured to exchange data via differential data lines during High Speed mode. At least one switch is set to an open state in response to a transition of the PHY from a chirp mode to the High Speed mode to capacitively couple the differential data lines to one or more components of the High Speed module via a set of capacitors.

### CROSS-REFERENCE TO RELATED APPLICATIONS

The present Application for Patent claims the benefit of U.S. Provisional Application No. 62/265,171, entitled “CAPACITIVE COUPLING OF HIGH-SPEED USB SIGNALING TO ADDRESS ISSUES ASSOCIATED WITH GROUND OFFSET VOLTAGES CREATED BY HIGH CHARGING CURRENTS”, filed Dec. 9, 2015, which is by the same inventors as the subject application, assigned to the assignee hereof and expressly incorporated by reference herein in its entirety.

### BACKGROUND

1. Field of the Disclosure

Embodiments relate to capacitive coupling of High-speed USB signaling to address issues associated with ground offset voltages created by high charging currents.

2. Description of the Related Art

Universal Serial Bus (USB) 2.0 (“USB2”) defines a USB protocol that permits host devices to connect to one or more peripheral devices. In particular, in USB2, USB ports use differential data pins (D+/− lines) for a variety of functions, including determining whether an external device connects to or disconnects from a USB port (via a USB2-compliant cable), establishing and maintaining data transfer with the external device (if connected), charger detection, and so on. These differential data pins are deployed within the physical layer interface circuitry (referred to as Physical Layer Interface Transceiver, or “PHY”) that is used to connect to PHYs at external devices. USB PHYs can operate in a Low Speed mode (e.g., up to 1.5 Mbps), a Full Speed mode (e.g., up to 12 Mbps) or a High Speed mode (e.g., up to 480 Mbps).

Originally, USB2 defined a Direct Current (DC)-coupled interface that was permitted to provide up to 500 mA of current from a host device to a peripheral device. However, over time, several industry standards have increased the charging current used by USB2 devices to several amps. An increase to the charging current also increases a ground offset between the host device and the peripheral device, which can degrade performance of USB2 PHYs operating in the High Speed mode.

For example, modern cars typically support USB connectivity, with the USB host implemented in a head unit located in the dash of the car and peripheral ports located in other areas of the car (e.g., the back of the car, etc.). A cable connecting the USB host to one of the peripheral ports can be several meters long. Certain industry standards require the peripheral ports to support charging currents greater than 2 A. This amount of current going through the ground of the cable results in a significant voltage offset between the head unit and the peripheral ports. This offset can cause performance degradation in USB2 PHYs during operation in High Speed mode.

In addition to the ground offset issue, certain industry standards require there to be multiple components on the D+/− lines between the host and the peripheral ports, such as video switches, chokes, electrostatic discharge (ESD) and charger detection circuitry. These components cause attenuation on signals exchanged by USB2 PHYs during operation in High Speed mode, which further adds to the performance degradation in USB2 PHYs during operation in High Speed mode.

### SUMMARY

An embodiment is directed to a Physical Layer Interface Transceiver (PHY) that is configured to operate in accordance with a Universal Serial Bus 2.0 (USB2) protocol, including a High Speed module configured to exchange data via differential data lines during High Speed mode, at least one switch being set to an open state in response to a transition of the PHY from a chirp mode to the High Speed mode to capacitively couple the differential data lines to one or more components of the High Speed module via a set of capacitors.

Another embodiment is directed to a method of operating a PHY in accordance with the USB2 protocol, including setting at least one switch to an open state in response to a transition of the PHY from a chirp mode into a High Speed mode to capacitively couple differential data lines to one or more components of a High Speed module of the PHY via a set of capacitors.

Another embodiment is directed to PHY that is configured to operate in accordance with the USB2 protocol, including means for transitioning the PHY from a chirp mode into a High Speed mode, and means for setting at least one means for switching to an open state in response to the transition of the PHY from the chirp mode into the High Speed mode to capacitively couple differential data lines to one or more components of a High Speed module of the PHY via a set of capacitors.

Another embodiment is directed to non-transitory computer-readable storage medium containing instructions stored thereon, which, when executed by a PHY that is configured to operate in accordance with the USB2 protocol, causes the PHY to perform operations, the instructions including at least one instruction to cause the PHY to set at least one switch to an open state in response to a transition of the PHY from a chirp mode into a High Speed mode to capacitively couple differential data lines to one or more components of a High Speed module of the PHY via a set of capacitors.

### BRIEF DESCRIPTION OF THE DRAWINGS

A more complete appreciation of embodiments of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a device that is configured to connect to one or more external devices via a Universal Serial Bus (USB) connection in accordance with an embodiment of the disclosure.

FIG. 2 illustrates a USB Version 2.0 (USB2) Physical Layer Interface for High Speed USB (PHY) of a host device that is connected to a USB2 PHY of a peripheral device.

FIG. 3 depicts a direct current of 0.5 A (or 500 mA) being delivered over a voltage bus of FIG. 2.

FIG. 4 depicts a direct current of 1.5 A (or 1500 mA) being delivered over the voltage bus of FIG. 2.

FIG. 5 illustrates a USB2 PHY of a host device that is connected to a USB2 PHY of a peripheral device in accordance with an embodiment of the disclosure.

FIG. 6 depicts the host USB2 PHY of FIG. 5 connected to the peripheral USB2 PHY of FIG. 2 in accordance with an embodiment of the disclosure.

FIG. 7 depicts the host USB2 PHY of FIG. 2 connected to the peripheral USB2 PHY of FIG. 5 in accordance with an embodiment of the disclosure.

FIG. 8 depicts the arrangement of FIG. 6 whereby the host USB2 PHY described with respect to FIG. 5 is connected to the peripheral USB2 PHY of FIG. 2 while a direct current of 1.5 A (or 1500 mA) is delivered over a voltage bus in accordance with an embodiment of the present disclosure.

FIG. 9 illustrates examples of ground offset drift that can occur when switches are in an open state during High Speed mode packet transfer with respect to any of the configurations shown in FIGS. 5-7 in accordance with an embodiment of the disclosure.

FIG. 10 illustrates a process of controlling switches of a PHY in accordance with an embodiment of the disclosure.

FIG. 11 illustrates an example implementation of the process of FIG. 10 in accordance with an embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

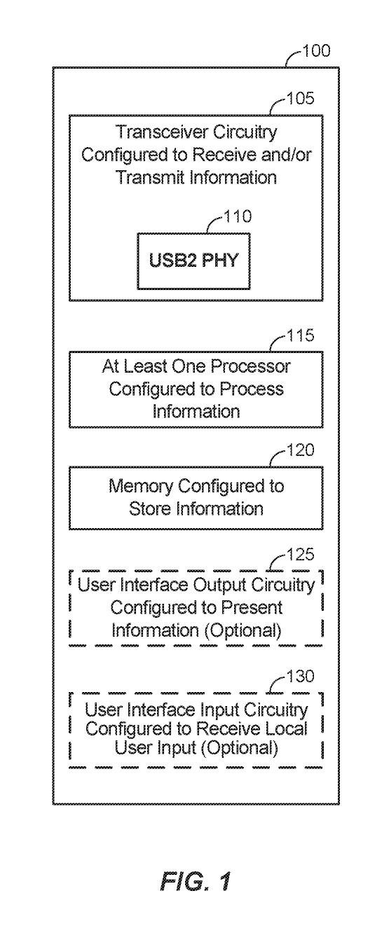

FIG. 1 illustrates a device 100 that is configured to connect to one or more external devices via a Universal Serial Bus (USB) connection in accordance with an embodiment of the disclosure. The device 100 can correspond to either a host device or a peripheral device with respect to the USB connection. For example, the device 100 may be a host device that is deployed in a head unit in the dash of a car, and configured to connect to a peripheral device (e.g., a phone, a tablet computer, headset, etc.) via a peripheral port in the car that is cable-connected to the device 100. In another example, the device 100 may correspond to a laptop or desktop computer that is acting as a host device with respect to a peripheral device such as a phone, keyboard, mouse or printer. Alternatively, in any of the aforementioned examples, the device 100 may correspond to the peripheral device and not the host device. Accordingly, the device 100 is intended to be broadly construed as any device that is capable of establishing and supporting a USB connection.

Referring to FIG. 1, the device 100 includes transceiver circuitry configured to receive and/or transmit information 105. In particular, the transceiver circuitry configured to receive and/or transmit information 105 includes a Physical Layer Interface for High Speed USB, or “PHY”, that is compliant with USB 2.0 (USB2) and is hereinafter referred to as USB2 PHY 110. The USB2 PHY 110 will be described in more detail below.

Referring to FIG. 1, the device 100 further includes at least one processor configured to process information 115. Example implementations of the type of processing that can be performed by the at least one processor configured to process information 115 includes but is not limited to performing determinations, establishing connections, making selections between different information options, performing evaluations related to data, interacting with sensors coupled to the communication device 115 to perform measurement operations, converting information from one format to another (e.g., between different protocols such as .wmv to .avi, etc.), and so on. For example, the at least one processor configured to process information 115 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 115 may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The at least one processor configured to process information 115 can also include software that, when executed, permits the associated hardware of the at least one processor configured to process information 115 to perform its processing function(s). However, the at least one processor configured to process information 115 does not correspond to software alone, and the at least one processor configured to process information 115 relies at least in part upon structural hardware to achieve its functionality. Moreover, the at least one processor configured to process information 115 may be implicated by language other than “processing”, as long as the underlying function corresponds to a processing function. For an example, functions such as evaluating, determining, calculating, identifying, etc., may be performed by the at least one processor configured to process information 115 in certain contexts as being specific types of processing functions. Other functions that correspond to other types of processing functions may also be performed by the at least one processor configured to process information 115.

Referring to FIG. 1, the device 100 further includes memory configured to store information 120. In an example, the memory configured to store information 120 can include at least a non-transitory memory and associated hardware (e.g., a memory controller, etc.). For example, the non-transitory memory included in the memory configured to store information 120 can correspond to RAM, flash memory, ROM, erasable programmable ROM (EPROM), EEPROM, registers, hard disk, a removable disk, a CD-ROM, or any other form of storage medium known in the art. The memory configured to store information 120 can also include software that, when executed, permits the associated hardware of the memory configured to store information 120 to perform its storage function(s). However, the memory configured to store information 120 does not correspond to software alone, and the memory configured to store information 120 relies at least in part upon structural hardware to achieve its functionality. Moreover, the memory configured to store information 120 may be implicated by language other than “storing”, as long as the underlying function corresponds to a storing function. For an example, functions such as caching, maintaining, etc., may be performed by the memory configured to store information 120 in certain contexts as being specific types of storing functions. Other functions that correspond to other types of storing functions may also be performed by the memory configured to store information 120.

Referring to FIG. 1, the device 100 further optionally includes user interface output circuitry configured to present information 125. In an example, the user interface output circuitry configured to present information 125 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the device 100. For example, if the device 100 corresponds to a client device (e.g., laptop, cell phone, tablet computer, etc., the user interface output circuitry configured to present information 125 can include a display. In a further example, the user interface output circuitry configured to present information 125 can be omitted for certain communication devices, such as network communication devices that do not have a local user (e.g., flash drives, headsets, network switches or routers, remote servers, etc.). The user interface output circuitry configured to present information 125 can also include software that, when executed, permits the associated hardware of the user interface output circuitry configured to present information 125 to perform its presentation function(s). However, the user interface output circuitry configured to present information 125 does not correspond to software alone, and the user interface output circuitry configured to present information 125 relies at least in part upon structural hardware to achieve its functionality. Moreover, the user interface output circuitry configured to present information 125 may be implicated by language other than “presenting”, as long as the underlying function corresponds to a presenting function. For an example, functions such as displaying, outputting, prompting, conveying, etc., may be performed by the user interface output circuitry configured to present information 125 in certain contexts as being specific types of presenting functions. Other functions that correspond to other types of storing functions may also be performed by the user interface output circuitry configured to present information 125.

Referring to FIG. 1, the device 100 further optionally includes user interface input circuitry configured to receive local user input 130. In an example, the user interface input circuitry configured to receive local user input 130 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the device 100. For example, if the device 100 corresponds to a client device (e.g., laptop, cell phone, tablet computer, etc.), the user interface input circuitry configured to receive local user input 130 can include buttons, a display (e.g., a touchscreen), etc. In a further example, the user interface input circuitry configured to receive local user input 130 can be omitted for certain communication devices, such as network communication devices that do not have a local user (e.g., network switches or routers, remote servers, etc.). The user interface input circuitry configured to receive local user input 130 can also include software that, when executed, permits the associated hardware of the user interface input circuitry configured to receive local user input 130 to perform its input reception function(s). However, the user interface input circuitry configured to receive local user input 130 does not correspond to software alone, and the user interface input circuitry configured to receive local user input 130 relies at least in part upon structural hardware to achieve its functionality. Moreover, the user interface input circuitry configured to receive local user input 130 may be implicated by language other than “receiving local user input”, as long as the underlying function corresponds to a receiving local user function. For an example, functions such as obtaining, receiving, collecting, etc., may be performed by the user interface input circuitry configured to receive local user input 130 in certain contexts as being specific types of receiving local user functions. Other functions that correspond to other types of receiving local user input functions may also be performed by the user interface input circuitry configured to receive local user input 130.

Referring to FIG. 1, while the configured structural components of 105 through 130 are shown as separate or distinct blocks in FIG. 1 that are implicitly coupled to each other via an associated communication bus (not shown expressly), it will be appreciated that the hardware and/or software by which the respective configured structural components of 105 through 130 performs their respective functionality can overlap in part. For example, any software used to facilitate the functionality of the configured structural components of 105 through 130 can be stored in the non-transitory memory associated with the memory configured to store information 120, such that the configured structural components of 105 through 130 each performs their respective functionality (i.e., in this case, software execution) based in part upon the operation of software stored by the memory configured to store information 120. Likewise, hardware that is directly associated with one of the configured structural components of 105 through 130 can be borrowed or used by other of the configured structural components of 105 through 130 from time to time. For example, the at least one processor configured to process information 115 can format data into an appropriate format before being transmitted by the transceiver circuitry configured to receive and/or transmit information 110, such that the transceiver circuitry configured to receive and/or transmit information 110 performs its functionality (i.e., in this case, transmission of data) based in part upon the operation of structural hardware associated with the at least one processor configured to process information 115.

Accordingly, the various structural components of 105 through 130 are intended to invoke an aspect that is at least partially implemented with structural hardware, and are not intended to map to software-only implementations that are independent of hardware and/or to non-structural functional interpretations. Other interactions or cooperation between the structural components of 105 through 130 in the various blocks will become clear to one of ordinary skill in the art from a review of the aspects described below in more detail.

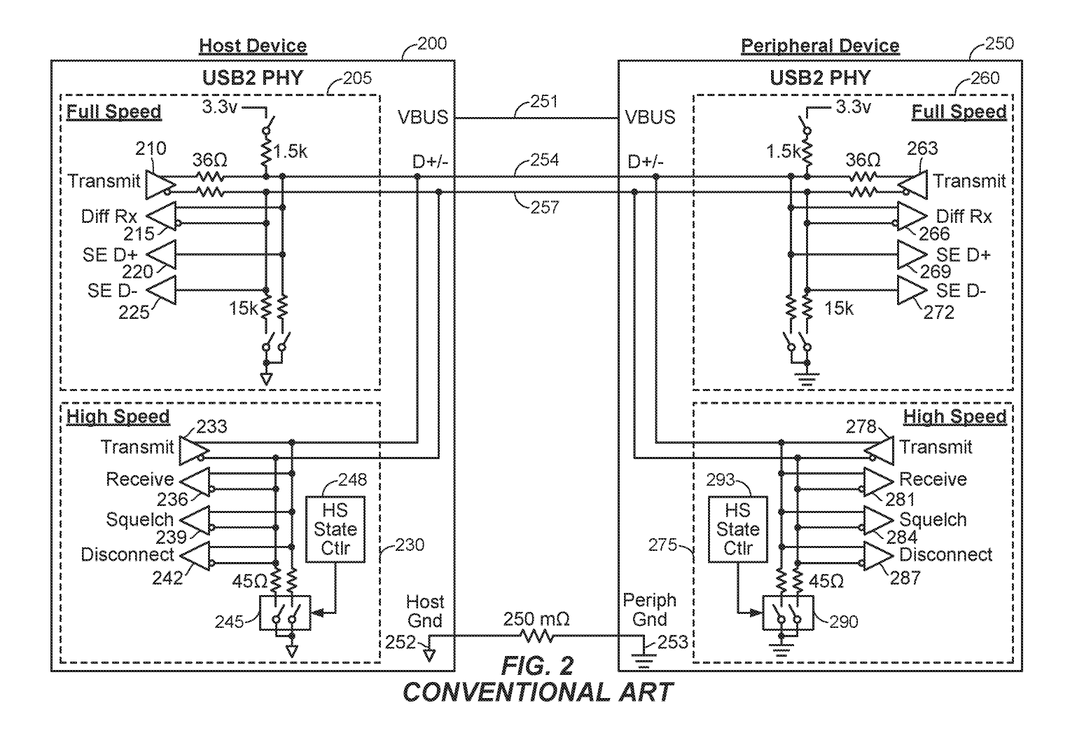

FIG. 2 illustrates a USB2 PHY 200 of a host device that is connected to a USB2 PHY 250 of a peripheral device.

Referring to FIG. 2, the USB2 PHY 200 includes a Full Speed module 205 that includes a transmitter 210, a differential receiver 215 and a differential driver (for D+/− lines), 220 and 225. The Full Speed module 205 also includes a number of switches, resistors, bus connections, etc. that are specified by USB2. The USB2 PHY 200 further includes a High Speed module 230 that includes a transmitter 233, a receiver 236, a squelch detector 239 and a disconnect detector 242. Certain switches, such as switches 245, in the High Speed module 230 are controlled by a High Speed State Controller 248.

The USB2 PHY 200 at the host device supplies a direct current to the USB2 PHY 250 via a voltage bus 251, a host ground 252 at the USB PHY 200 and a peripheral ground 253 at the USB PHY 250. USB2 also allows a ground impedance of up to 250 mΩ (this is the maximum ground impedance allowed by the USB2.0 Specification), as shown between the host ground 252 and the peripheral ground 253. Data is carried via differential data lines (D+/−), 254 and 257. The various interconnections between the USB2 PHYs 500 and 520 (e.g., host ground 252 and peripheral ground 253, D+/− lines 254 and 257, and voltage bus 251) correspond at least in part to a USB2-compliant cable that connects the host device to the peripheral device.

Referring to FIG. 2, the USB2 PHY 250 includes a Full Speed module 260 that includes a transmitter 263, a differential receiver 266 and a differential driver (for D+/− lines), 269 and 272. The Full Speed module 260 also includes a number of switches, resistors, bus connections, etc. that are specified by USB2. The USB2 PHY 250 further includes a High Speed module 275 that includes a transmitter 278, a receiver 281, a squelch detector 284 and a disconnect detector 287. Certain switches, such as switches 290, in the High Speed module 275 are controlled by a High Speed State Controller 293. The structure depicted in FIG. 2 is conventional in the art and would be understood by one of ordinary skill in the art.

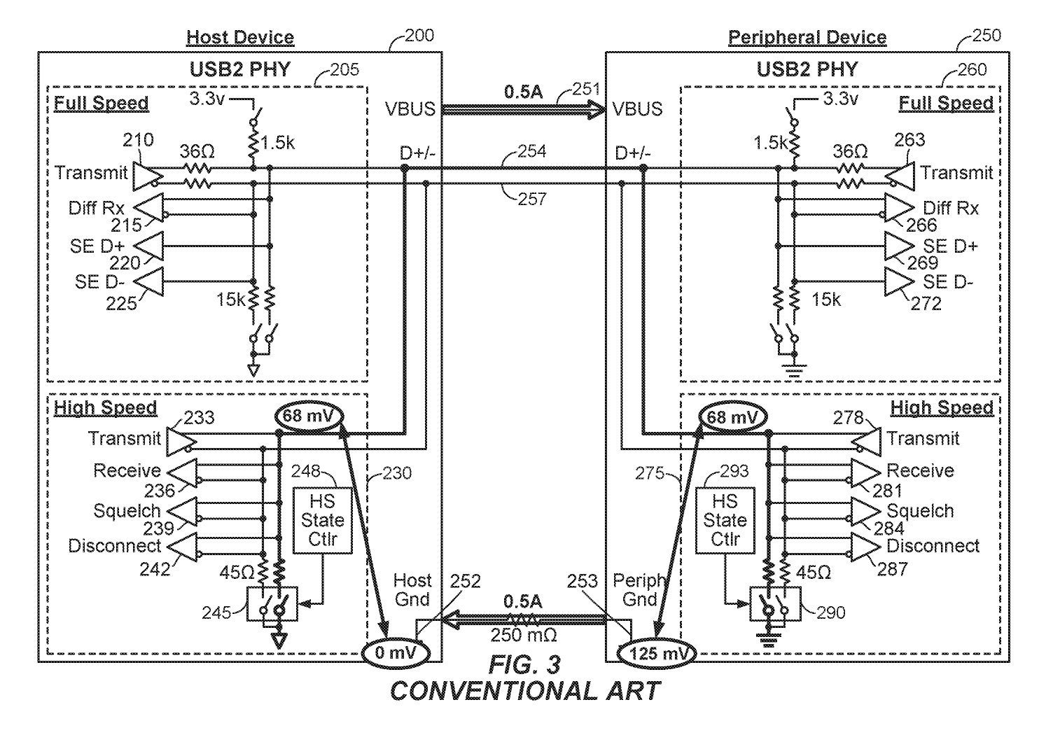

USB2 was originally specified to provide up to 500 mA of current from the host device to the peripheral device. Accordingly, FIG. 3 depicts a direct current of 0.5 A (or 500 mA) being delivered over the voltage bus 251 of FIG. 2. In this scenario, the components (i.e., transmitter 233, receiver 236, squelch detector 239 and disconnect detector 242) of the High Speed module 230 operate with a 68 mV offset between the differential data lines (D+/−) 254 and 257 (68 mV) and the host ground 252 (0 mV). The components (i.e., transmitter 278, receiver 281, squelch detector 284 and disconnect detector 287) of the High Speed module 275 operate with a −68 mV offset between the differential data lines (D+/−) 254 and 257 (68 mV) and the peripheral ground 253 (125 mV).

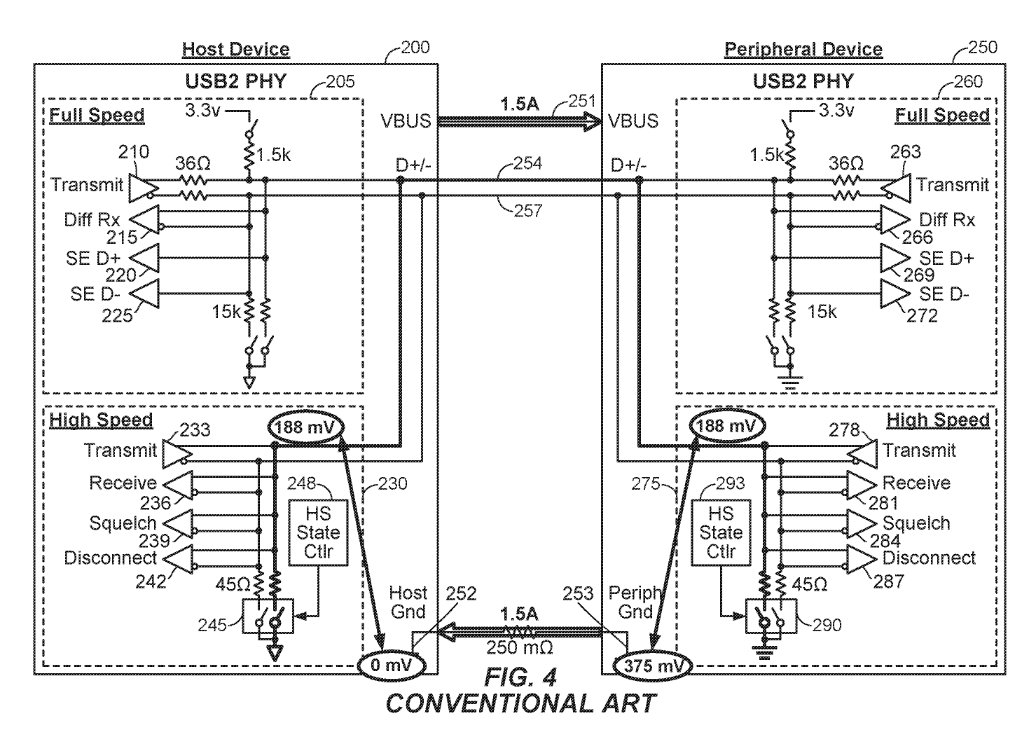

More recently, the USB Battery Specification Version 1.2 allows the charging current supplied by a host device to a peripheral device to reach 1.5 A without modifying the ground impedance of 250 mΩ. Accordingly, FIG. 4 depicts a direct current of 1.5 A (or 1500 mA) being delivered over the voltage bus 251 of FIG. 2. In this scenario, the components (i.e., transmitter 233, receiver 236, squelch detector 239 and disconnect detector 242) of the High Speed module 230 operate with a 188 mV offset between the differential data lines (D+/−) 254 and 257 (188 mV) and the host ground 252 (0 mV). The components (i.e., transmitter 278, receiver 281, squelch detector 284 and disconnect detector 287) of the High Speed module 275 operate with a −188 mV offset between the differential data lines (D+/−) 254 and 257 (188 mV) and the peripheral ground 253 (375 mV).

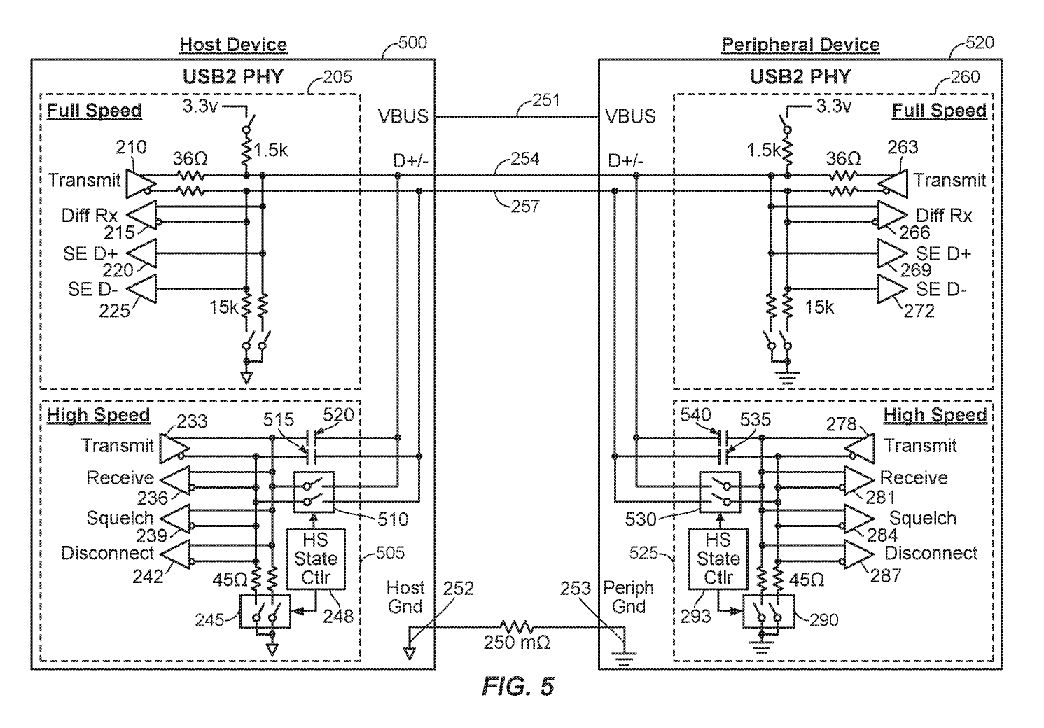

FIG. 5 illustrates a USB2 PHY 500 of a host device that is connected to a USB2 PHY 520 of a peripheral device in accordance with an embodiment of the disclosure. Referring to FIG. 5, like-numbered structure corresponds to structure that was already described with respect to FIG. 2 and will not be described further for the sake of brevity. In the embodiment of FIG. 5, a High Speed module 505 in USB2 PHY 500 includes switches 510 which are connected to and controlled by the High Speed State Controller 248. The High Speed module 505 is also provisioned with capacitors 515 and 520. Further, in the embodiment of FIG. 5, a High Speed module 525 in USB2 PHY 520 includes switches 530 which are connected to and controlled by the High Speed State Controller 293. The High Speed module 505 is also provisioned with capacitors 535 and 540. The capacitors 515, 520, 535 and 540 may be located either on silicon (e.g., within the respective PHYs, as depicted in FIG. 5) or external to the respective PHYs (e.g., at board level). Expanding on this point, while not expressly shown in FIGS. 5-7, one or more of the capacitors 515, 520, 535 and/or 540 may be implemented as external components that are not physically part of the respective USB2 PHYs 500 and 520. If any of capacitors 515, 520, 535 and/or 540 are implemented externally to the respective PHYs, then one or more external pins may be used to connect the respective PHYs to the external capacitors. In a further example, as shown in FIG. 5, the capacitors 515 and 520 may be deployed in series between the differential data lines (D+/−) 254 and 257 and one or more components (e.g., the transmitter 233, receiver 236, squelch detector 239 and/or host disconnect detector 242, etc.) of the High speed module 505. Likewise, in another example, as shown in FIG. 5, the capacitors 535 and 540 may also be deployed in series between the differential data lines (D+/−) 254 and 257 and one or more components (e.g., the transmitter 278, receiver 281, squelch detector 284 and/or host disconnect detector 287, etc.) of the High speed module 525.

Referring to FIG. 5, when the Peripheral device is attached to the Host device, charging current flows from the Host device to the Peripheral device and returns through the ground impedance. This charging current generates a voltage offset between the Peripheral Ground 253 and Host Ground 252. This voltage offset causes an additional current to flow from Peripheral Ground 253 to Host Ground 252 through the 45 ohm termination resistors 245 and 290. This additional current results in the D+/− lines 254 and 257 having a positive DC offset with respect to Host Ground 252, and a negative DC offset with respect to Peripheral Ground 253.

Before starting a High Speed communication session, the switches 510 and/or 530 are closed, and the High Speed module 505 of the Host PHY 500 is DC coupled to the High Speed module 525 of the Peripheral PHY. This DC coupling causes the Host PHY 500 and the Peripheral PHY 520 to each enter into a chirp mode, whereby low frequency chirp pulses associated with a speed negotiation protocol are passed between Host PHY 500 and the Peripheral PHY 520. This DC offset does not cause communication issues because the chirp pulses have high amplitude (i.e., ˜800 mV), and the common mode voltage of the chirps remains within the common range of required by USB2. After the speed negotiation protocol completes, the chirp mode ends and the Host PHY 500 and the Peripheral PHY 520 enter into the High Speed mode. In an example, the transition from the chirp mode to the High Speed mode occurs when a pull-up resistor (not shown) on the function side is set to OFF, allowing the pull-up resistor to function as a USB2 High Speed buffer.

In response to the transition of a respective PHY (i.e., the Host PHY 500 and/or the Peripheral PHY 520) from the chirp mode into the High Speed mode, the switches 510 and/or 530 are opened, and the High Speed module 505 of the Host PHY 500 is AC coupled to the High Speed module 525 of the Peripheral PHY 520. This AC coupling blocks any DC current from flowing through the 45 ohm termination resistors 245 and 290. As a result, the D+/− inputs to the High Speed module 505 of the Host PHY 500 do not have any initial DC offset at the start of each packet with respect to Host Ground 252. Similarly, the D+/− inputs to the High Speed module 525 of the Peripheral PHY 520 do not have any DC offset at the start of each packet with respect to Peripheral Ground 253. Over the course of the packet, the DC offset of the PHY inputs will change due to charging of the capacitors 515, 520, 535 and 540, but the DC offset always remains within the Common Mode range of the PHY inputs as required by USB2.

In particular, per USB2, High Speed State Controllers are required to place their respective USB2 PHY in Full Speed mode (DC mode or chirp mode) first in order to conduct a handshake protocol with an external USB2 PHY, after which the USB2 PHY is moved to High Speed mode (AC mode). In the embodiment of FIG. 5, one or more signals configured to be output by the High Speed State Controllers are leveraged to control the switches 510 and 530 so as to be set to the open state when the USB2 PHY is transitioned from the Full Speed mode (or chirp mode) into the High Speed mode, and to set the switches 510 and 530 back to the closed state when the USB2 PHY transitions from the High Speed mode back to the Full Speed mode (e.g., such that the switches 510 and 530 remain in the closed state while the USB2 PHY remains in the Full Speed mode or transitions to Low Speed mode, with the switches 510 and 530 being opened again the next time the USB2 PHY transitions from the chirp mode to the High Speed mode). The transition of the USB2 PHY back from the High speed mode to the Full Speed mode involves, suspend, reset and detach procedures, as is known in the art.

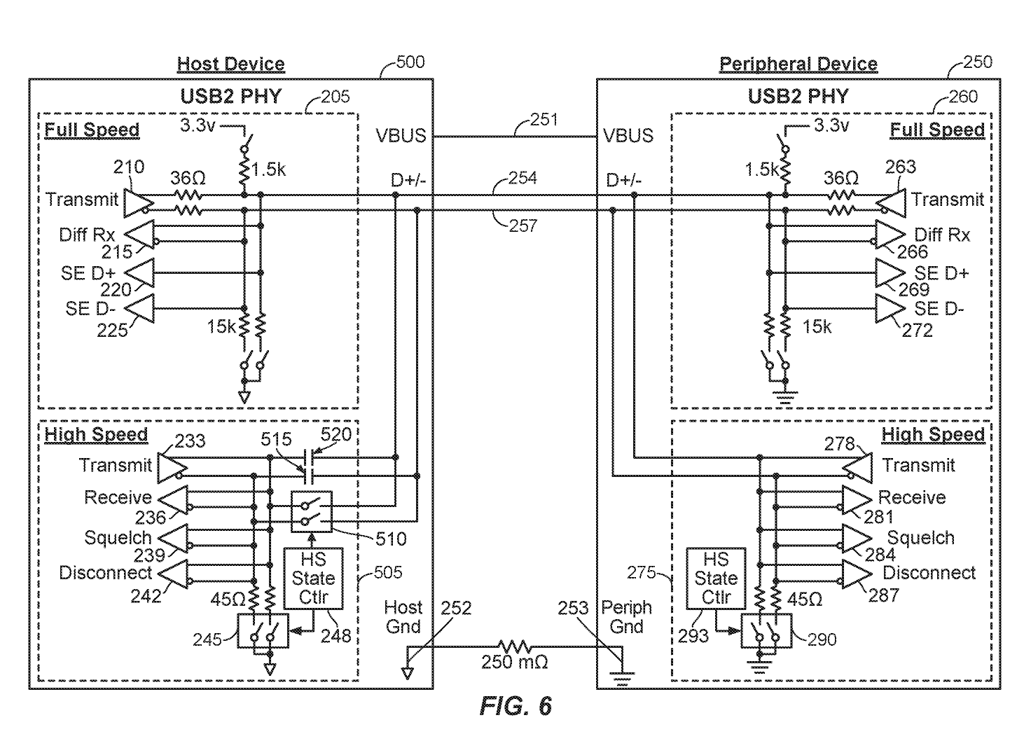

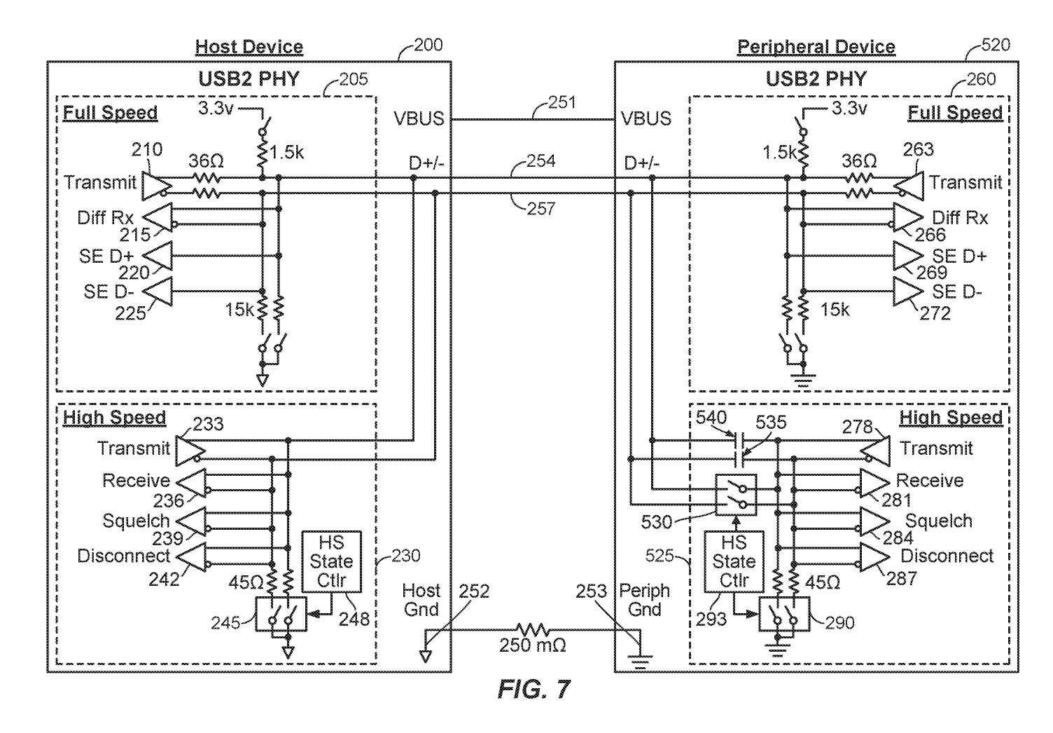

As will be appreciated, the switch and capacitor arrangement described with respect to FIG. 5 need only be present in one of the USB2 PHYs in order to eliminate the initial ground offsets in both respective USB2 PHYs. So, a USB2 PHY configured as in FIG. 5 can be used with legacy devices (e.g., such as the USB2 PHYs depicted in FIG. 2) while still selectively reducing or eliminating the respective ground offsets during High Speed mode. This implementation is depicted in FIGS. 6-7, whereby FIG. 6 depicts a host device with USB2 PHY 500 of FIG. 5 connected to a peripheral device with the USB2 PHY 250 of FIG. 2, and FIG. 7 depicts a host device with USB2 PHY 200 of FIG. 2 connected to a peripheral device with the USB2 PHY 520 of FIG. 5.

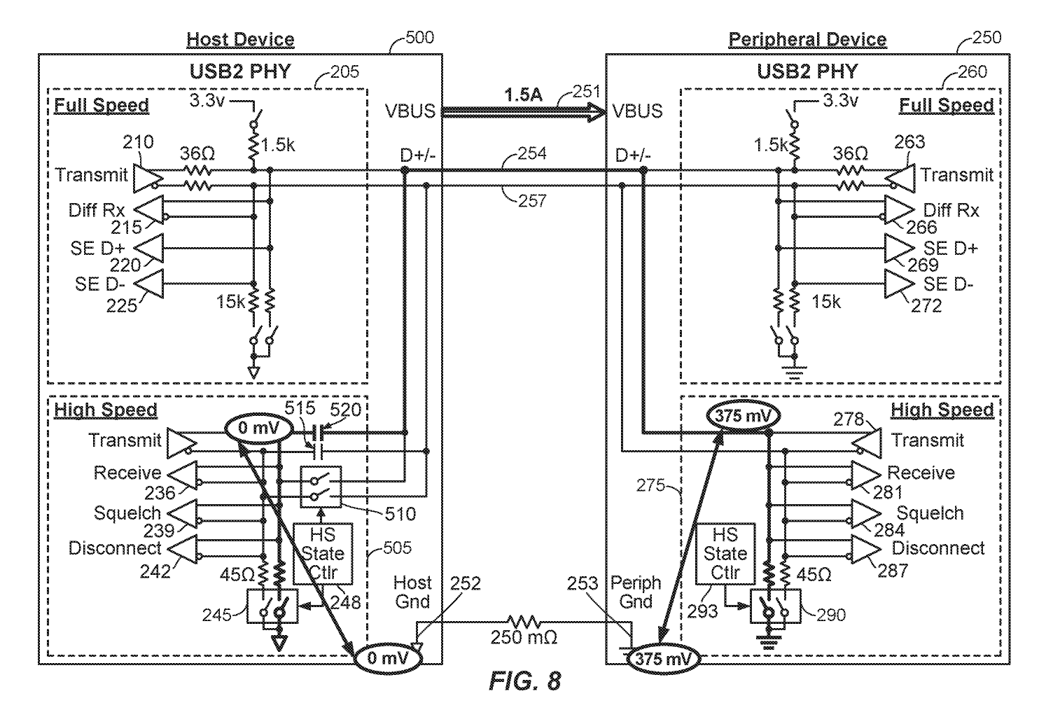

Accordingly, FIG. 8 depicts the arrangement of FIG. 6 whereby the USB2 PHY 500 described with respect to FIG. 5 is connected to the USB2 PHY 250 of FIG. 2 while a direct current of 1.5 A (or 1500 mA) is delivered over the voltage bus 251 in accordance with an embodiment of the present disclosure. In this scenario, as illustrated in FIG. 8 with the switches 510 in the open state, the components (i.e., transmitter 233, receiver 236, squelch detector 239 and disconnect detector 242) of the High Speed module 505 operate with an initial 0 mV offset between the differential data lines (D+/−) 254 and 257 (0 mV) and the host ground 252 (0 mV). The components (i.e., transmitter 278, receiver 281, squelch detector 284 and disconnect detector 287) of the High Speed module 275 operate with an initial 0 mV offset between the differential data lines (D+/−) 254 and 257 (375 mV) and the peripheral ground 253 (375 mV). While not shown expressly in FIG. 8, if the switches 510 were set to the closed state instead of the open state, the components (i.e., transmitter 233, receiver 236, squelch detector 239 and disconnect detector 242) of the High Speed module 505 would operate with a 188 mV offset between the differential data lines (D+/−) 254 and 257 (188 mV) and the host ground 252 (0 mV), and the components (i.e., transmitter 278, receiver 281, squelch detector 284 and disconnect detector 287) of the High Speed module 275 would operate with a −188 mV offset between the differential data lines (D+/−) 254 and 257 (188 mV) and the peripheral ground 253 (375 mV). While the embodiment of FIG. 8 depicts the arrangement of FIG. 8, it will be appreciated that the above-noted initial ground offsets may also be achieved for the switches 510 and/or 530 in the open state in the arrangements of FIG. 5 or FIG. 7 as well. In other words, so long as one side of the USB connection (host or peripheral device) is equipped with the above-noted switch and capacitor arrangement, the initial ground offsets at the USB2 PHYs of the host device and peripheral device can be reduced or eliminated.

It will be appreciated that the above-noted ground offsets that occur while the switches 510 and/or 530 are in the open state refer to the initial ground offsets at the start of a packet when the time between packets has been long enough to allow the voltage across the capacitors to fully settle. During the course of a packet, the capacitors 515, 520, 535 and 540 will begin to charge somewhat which may cause some degree of ground offset. Accordingly, for long packets (or chirps) that cause the High Speed mode to be maintained for a relatively long period of time (e.g., 300 ns, 400 ns, 500 ns, etc.), the ground offset may undergo drift.

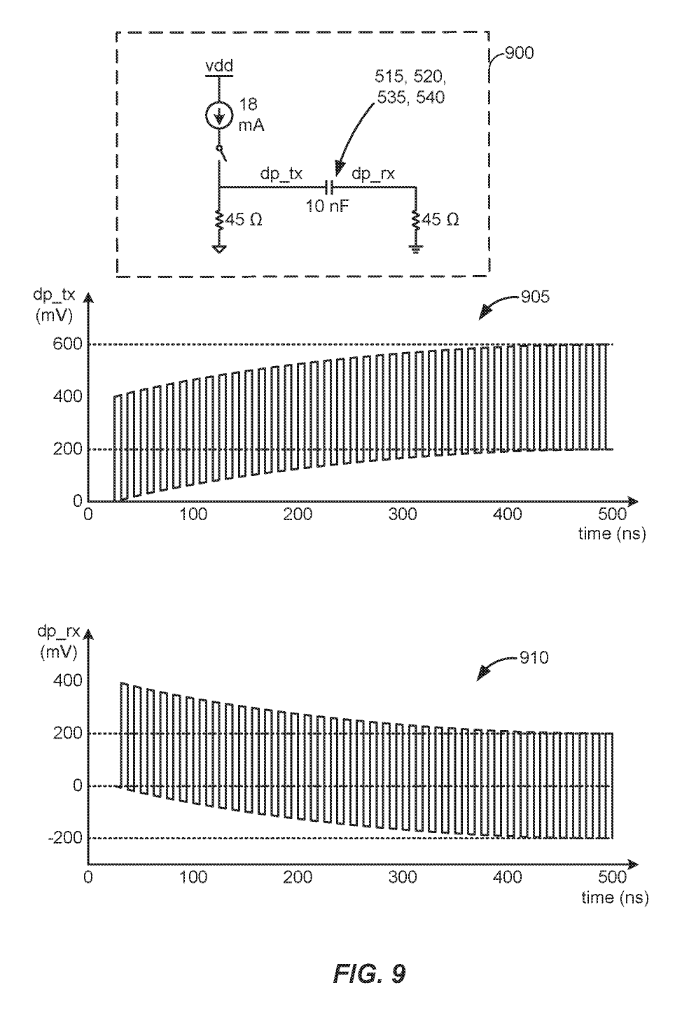

FIG. 9 illustrates examples of ground offset drift that can occur when the switches 510 and/or 530 are in an open state during High Speed mode packet transfer with respect to any of the configurations shown in FIGS. 5-7 in accordance with an embodiment of the disclosure. 900 of FIG. 9 depicts a particular arrangement of a portion of the USB2 PHYs 500 and 520 of FIGS. 5-7 whereby a 10 nF capacitor is representative of any of capacitors 515, 520, 535 and 540.

In the embodiment of FIG. 9, during High Speed mode after the switches 510 and/or 530 are opened such that the respective USB PHYs can be considered AC-coupled (because the High Speed data signals are carried via an alternating current), the common mode offsets of both the transmit and receive signals change over the duration of a packet. As shown in chart 905, the common mode offset of the transmit signal starts at 200 mV at the start of the packet, and increases to a steady state of 400 mV. As shown in chart 910, the common mode offset of the receive signal starts at 200 mV, and decreases to a steady state of 0 mV. The time constant of the offset change is equal to the capacitance times the sum of the termination impedance (e.g., 45Ω+45Ω=90Ω). Section 7.1.4.2 of USB2 requires a PHY to support common mode offsets from −50 mV to 500 mV. The steady state common mode offsets resulting from the 10 nF capacitor in the embodiment of FIG. 9 are 0 mV and 200 mV, which are well within the range required by USB2.

As will be appreciated from a review of FIG. 9, the above-noted embodiments that refer to the initial ground offset being 0 mV is relative to the direct current component. High Speed packet data that is sent over the differential data lines 254 and 257 during the High Speed mode adds an alternating current (AC) component which causes the common mode offset (which has an initial DC component of 0 mV) to fluctuate at a particular frequency, so the initial DC-based ground offset may be 0 mV at the start of High Speed mode while the common mode offset fluctuates based on the AC component (or traffic data) from the data packet being transmitted over the USB2 cable.

The size of the capacitors 515, 520, 535 and 540 can be configured to be large enough to pass the Start of Frame (SOF) End of Packet (EOP). The SOF EOP is 40 bits long. At the USB2 High Speed data rate of 480 Mbps, this equates to 83 ns. An example constraint is that the data lines not decay by more than 10% over the duration of the EOP. This constraint can be expressed as follows:

V_eop=(100%−10%)=exp[−t_eop/(R*C)] Equation (1)

where:

T_eop=83 ns

R=45Ω+45Ω=90Ω

C=high-speed series capacitance

C may then be solved, as follows:

C=−t_eop/[R*ln(0.9)]=−83ns/[900*ln(0.90]=9 nF Equation (2)

Thus, given the above assumptions, one appropriate value for C may be approximately 10 nF, as illustrated in FIG. 9. Various techniques may be employed to reduce the value of C. One technique would be to allow for greater range on the host disconnect threshold.

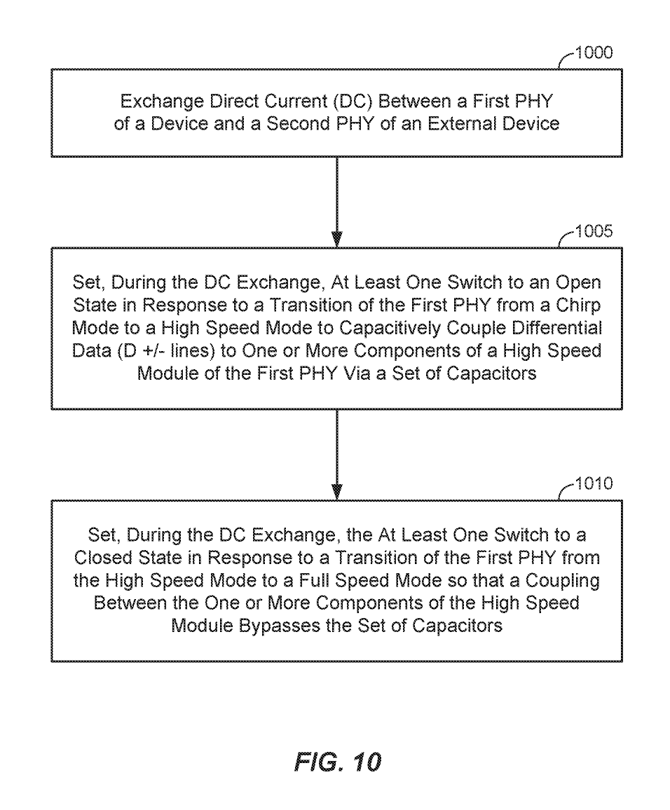

FIG. 10 illustrates a process of controlling switches of a PHY in accordance with an embodiment of the disclosure. The process of FIG. 10 can be implemented with respect to USB2 PHY 500 at the host device or USB2 PHY 520 at the peripheral device.

Referring to FIG. 10, a first PHY (e.g., USB2 PHY 500 or 520) of a device (e.g., a host device or peripheral device) exchanges direct current (DC) with a second PHY (e.g., USB2 PHY 500 or 520) of an external device (e.g., a host device or peripheral device), 1000. The first and second PHYs are connected and communicate via a USB2 connection in the chirp mode to conduct the speed negotiation protocol, as described above. At 1005, while the DC is being exchanged between the first PHY and the second PHY, the first PHY sets at least one switch (e.g., the switches 510 or 530) coupled to a first High Speed module (e.g., High Speed module 505 or 525) of the first PHY to an open state in response to a transition of the first PHY from the chirp mode to the High Speed mode to capacitively couple differential data (D+/− lines) to one or more components (e.g., a differential driver, a differential receiver, a squelch detector and/or a host disconnect detector) of the first High Speed module of the first PHY via a set of capacitors (e.g., capacitors 515, 520, 535 and/or 540). In an example, the at least one switch being set to the open state at 1005 may cause an initial ground offset between the first and second High Speed modules and corresponding grounds on their respective PHYs to be zero by virtue of the positioning and configuration of at least one capacitor as described above. At 1010, while the DC is being exchanged between the first PHY and the second PHY, the first PHY further sets the at least one switch to a closed state in response to a transition of the first PHY from the High Speed mode to the Full Speed mode (e.g., suspend, reset and detach) so that a coupling between the one or more components of the High Speed module bypasses the set of capacitors.

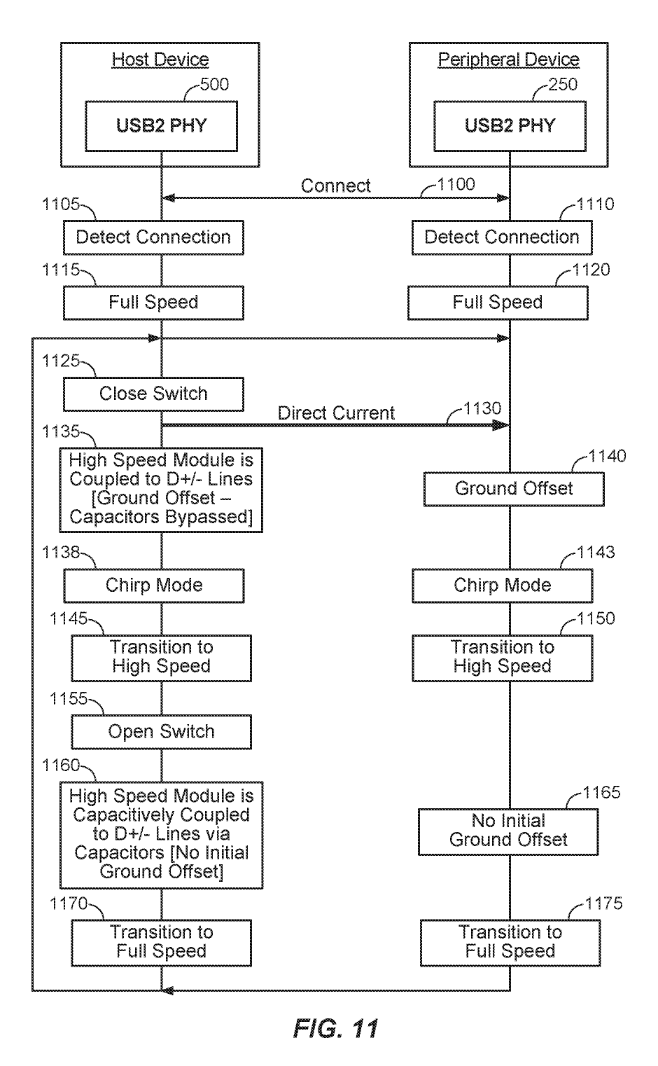

FIG. 11 illustrates an example implementation of the process of FIG. 10 in accordance with an embodiment of the disclosure. In particular, the process of FIG. 11 corresponds to an implementation based on the arrangement depicted in FIGS. 6 and 8 whereby the USB2 PHY 500 is connected to a legacy USB2 PHY 250 that is not equipped with switches and/or capacitors for manipulating a ground offset during High Speed mode.

Referring to FIG. 11, USB2 PHY 500 and USB2 PHY 250 are connected, 1100. For example, a user may plug a USB2 cable that is linked to the peripheral device into a peripheral port that is linked to the host device to form the connection at 1100. The respective USB2 PHYs 500 and 250 detect the connection, 1105 and 1110, and enter Full Speed mode, 1115 and 1120. At this point, the High Speed State Controller 248 closes the switches 510 (or if the switches 510 are already closed, maintains these switches in a closed state), 1125 (e.g., as in 1010 of FIG. 10), and the host device delivers a direct current (or charging current) over the voltage bus 251, 1130 (e.g., as in 1000 of FIG. 10).

Because the connection between the USB2 PHYs 500 and 250 is operating in Full Speed mode, the capacitors 515 and 520 are bypassed due to the switches 510 being closed (e.g., as in 1010 of FIG. 10) and a ground offset is present between components the High Speed modules 505 and 275 and their respective grounds 252 and 253, 1135 and 1140. However, the lower data rate of Full Speed mode (e.g., 12 Mbps) can tolerate these ground offsets, and the High Speed modules 505 and 275 are not actually active at this point so the ground offsets at the High Speed modules 505 and 275 can be ignored.

When the host device and peripheral device wish to exchange a larger amount of data, the host device and the peripheral device each transition to a chirp mode (as noted above, this is a form of Full Speed mode where a speed negotiation protocol is conducted), 1138 and 1143. When the speed negotiation protocol is completed, the host device and the peripheral device each transition from the chirp mode into the High Speed mode, 1145 and 1150. At this point, the High Speed State Controller 248 detects the transition of the from the chirp mode to the High Speed mode and opens the switches 510, 1155 (e.g., as in 1010 of FIG. 10). Opening the switches 510 at 1155 capacitively couples the differential data lines (D+/−) to the components of the High Speed modules 505 and 275, such that there is no initial ground offset between the High Speed modules and their corresponding grounds on their respective USB2 PHYs, 1160 and 1165. Some ground offset may occur due to drift as High Speed mode continues as described with respect to FIG. 9, but such ground offsets are expected to be within tolerable levels and compliant with the requirements of USB2.

When the host device and peripheral device complete the High Speed data transfer, the connection transitions back to Full Speed mode, 1170 and 1175. At this point, the process returns to 1125 where the High Speed State Controller 248 closes the switches 510 so that the differential data lines (D+/−) to the components of the High Speed modules 505 and 275 are no longer capacitively coupled (e.g., as in 1010 of FIG. 10), and so on.

While above-described embodiments refer to High Speed mode and Full Speed mode, as is known in the art, USB2 PHYs can always be backward compatible with Low Speed mode as well. Low Speed mode uses a rate of 1.5 Mbps, compared with 12 Mbps for Full Speed mode and 480 Mbps for High Speed mode. Generally, operation of the switches 510 and/or 530 and the capacitors 515, 520, 535 and/or 540 during Low Speed mode can be similar to Full Speed mode. In other words, the switches 510 and/or 530 are closed during Low Speed mode similar to Full Speed mode, and the switches 510 and/or 530 are then opened upon transition from chirp mode to High Speed mode and are closed again upon transition out of High Speed mode. Accordingly, while the focus of the embodiments described above with respect Full Speed mode and High Speed mode, other embodiments of the disclosure can further incorporate Low Speed mode as an alternative to Full Speed mode.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

What is claimed is:

1. A Physical Layer Interface Transceiver (PHY) that is configured to operate in accordance with a Universal Serial Bus 2.0 (USB2) protocol, comprising:
a High Speed module configured to exchange data via differential data lines during High Speed mode, at least one switch being set to an open state in response to a transition of the PHY from a chirp mode to the High Speed mode to capacitively couple the differential data lines to one or more components of the High Speed module via a set of capacitors.

2. The PHY of claim 1, wherein the one or more components of the High Speed module include a transmitter, a receiver, a squelch detector and/or a host disconnect detector.

3. The PHY of claim 1, wherein the at least one switch is further configured to be set to a closed state in response to a transition of the PHY from the High Speed mode to a Full-Speed mode so that a coupling between the one or more components of the High Speed module bypasses the set of capacitors.

4. The PHY of claim 1, further comprising:
a ground,
wherein an initial ground offset between the High Speed module and the ground is 0 mV after the at least one switch is set to the open state.

5. The PHY of claim 1,
wherein the set of capacitors is part of the PHY, or
wherein the set of capacitors is external to the PHY.

6. The PHY of claim 1,
wherein the PHY is provisioned at a host device, or
wherein the PHY is provisioned at a peripheral device.

7. The PHY of claim 1, wherein the at least one switch is set to a closed state while a PHY is operating in a Full Speed mode.

8. The PHY of claim 1, wherein the at least one switch is set to a closed state while a PHY is operating in a Low Speed mode.

9. The PHY of claim 1, wherein the set of capacitors is deployed in series between the differential data lines and the one or more components of the High Speed module.

10. A method of operating a Physical Layer Interface Transceiver (PHY) in accordance with a Universal Serial Bus 2.0 (USB2) protocol, comprising:
setting at least one switch to an open state in response to a transition of the PHY from a chirp mode into a High Speed mode to capacitively couple differential data lines to one or more components of a High Speed module of the PHY via a set of capacitors.

11. The method of claim 10, wherein the one or more components of the High Speed module include a transmitter, a receiver, a squelch detector and/or a host disconnect detector.

12. The method of claim 10, further comprising:
setting the at least one switch to a closed state in response to a transition of the PHY from the High Speed mode to a Full-Speed mode so that a coupling between the one or more components of the High Speed module bypasses the set of capacitors.

13. The method of claim 12, wherein the at least one switch remains in the closed state while the PHY is operating in a Full Speed mode.

14. The method of claim 12, wherein the at least one switch remains in the closed state while the PHY is operating in a Low Speed mode.

15. The method of claim 10, further comprising:
maintaining the at least one switch in the open state while the PHY is operating in the High Speed mode.

16. The method of claim 10, wherein an initial ground offset between the High Speed module and a ground is 0 mV after a transition of the at least one switch to the open state.

17. The method of claim 10, wherein the set of capacitors is deployed in series between the differential data lines and the one or more components of the High Speed module.

18. A Physical Layer Interface Transceiver (PHY) that is configured to operate in accordance with a Universal Serial Bus 2.0 (USB2) protocol, comprising:
means for transitioning the PHY from a chirp mode into a High Speed mode; and
means for setting at least one means for switching to an open state in response to the transition of the PHY from the chirp mode into the High Speed mode to capacitively couple differential data lines to one or more components of a High Speed module of the PHY via a set of capacitors.

19. The PHY of claim 18, wherein the one or more components of the High Speed module include a transmitter, a receiver, a squelch detector and/or a host disconnect detector.

20. The PHY of claim 18, wherein the at least one means for switching is further configured to be set to a closed state in response to a transition of the PHY from the High Speed mode to a Full-Speed mode so that a coupling between the one or more components of the High Speed module bypasses the set of capacitors.

21. The PHY of claim 18, further comprising:
a means for grounding,
wherein an initial ground offset between the High Speed module and the means for grounding is 0 mV after the at least one means for switching is set to the open state.

22. The PHY of claim 18,
wherein the set of capacitors is part of the PHY, or
wherein the set of capacitors is external to the PHY.

23. The PHY of claim 18,
wherein the PHY is provisioned at a host device, or
wherein the PHY is provisioned at a peripheral device.

24. The PHY of claim 18, wherein the at least one means for switching is set to a closed state while the PHY is operating in a Full Speed mode.

25. The PHY of claim 18, wherein the at least one means for switching is set to a closed state while the PHY is operating in a Low Speed mode.

26. The PHY of claim 18, wherein the set of capacitors is deployed in series between the differential data lines and the one or more components of the High Speed module.

27. A non-transitory computer-readable storage medium containing instructions stored thereon, which, when executed by a Physical Layer Interface Transceiver (PHY) that is configured to operate in accordance with a Universal Serial Bus 2.0 (USB2) protocol, causes the PHY to perform operations, the instructions comprising:
at least one instruction to cause the PHY to set at least one switch to an open state in response to a transition of the PHY from a chirp mode into a High Speed mode to capacitively couple differential data lines to one or more components of a High Speed module of the PHY via a set of capacitors.

28. The non-transitory computer-readable storage medium of claim 27, wherein the one or more components of the High Speed module include a transmitter, a receiver, a squelch detector and/or a host disconnect detector.

29. The non-transitory computer-readable storage medium of claim 27, further comprising:
at least one instruction to cause the PHY to set the at least one switch to a closed state in response to a transition of the PHY from the High Speed mode to a Full-Speed mode so that a coupling between the one or more components of the High Speed module bypasses the set of capacitors.

30. The non-transitory computer-readable storage medium of claim 29, wherein the at least one switch remains in the closed state while the PHY is operating in a Full Speed mode.

31. The non-transitory computer-readable storage medium of claim 29, wherein the at least one switch remains in the closed state while the PHY is operating in a Low Speed mode.

32. The non-transitory computer-readable storage medium of claim 27, further comprising:
at least one instruction to cause the PHY to maintain the at least one switch in the open state while the PHY is operating in the High Speed mode.

33. The non-transitory computer-readable storage medium of claim 27, wherein an initial ground offset between the High Speed module and a ground is 0 mV after a transition of the at least one switch to the open state.

34. The non-transitory computer-readable storage medium of claim 27, wherein the set of capacitors is deployed in series between the differential data lines and the one or more components of the High Speed module.
